(19) United States
(12) Patent Application Publication
(10) Pub. No.: US 2022/0064549 A1
(43) Pub. Date: Mar. 3, 2022

(54) HYDROCARBON CONVERSION PROCESS WITH RECYCLING OF REDUCTION EFFLUENTS

(71) Applicant: IFP Energies Nouvelles, Rueil-Malmaison (FR)

(72) Inventors: Aurelie DANDEU, Rueil-Malmaison (FR); Florent ALLAIN, Rueil-Malmaison (FR)

(73) Assignee: IFP Energies Nouvelles, Rueil-Malmaison (FR)

(21) Appl. No.: 17/415,050

(22) PCT Filed: Nov. 22, 2019
(86) PCT No.: PCT/EP2019/082263

§ 371 Date: Jun. 17, 2021

(30) Foreign Application Priority Data
Dec. 18, 2018 (FR) 1873163

(51) Int. Cl. C10G 59/02; B01J 23/96; B01J 38/02; B01J 38/10; B01J 38/44

(52) U.S. Cl. CPC C10G 59/02; B01J 23/96; B01J 38/02; B01J 38/10; B01J 38/44; C10G 2300/4006; C10G 2300/305; C10G 2300/708; C10G 2300/706; C10G 2300/1044; C10G 2300/308; C10G 2300/301; C10G 2300/4012

(57) ABSTRACT

The present invention relates to the field of the conversion of hydrocarbons and more particularly to that of catalytic reforming. A subject matter of the invention is a process employing at least two reaction zones, two reduction zones and one regeneration zone, and in which the effluents from the reduction zones are recycled, at least in part, at the top of each reaction zone.

### TECHNICAL FIELD

The present invention relates to the field of the conversion of hydrocarbons and more particularly to that of catalytic reforming. A subject matter of the invention is a process employing at least two reaction zones, two reduction zones and one regeneration zone, and in which the effluents from the reduction zones are recycled, at least in part, at the top of each reaction zone.

### PRIOR ART

The reforming (or catalytic reforming) of hydrocarbon cuts of the naphtha type is well known in the field of refining. This reaction makes it possible to produce, from these hydrocarbon cuts, bases for fuel having a high octane number and/or aromatic cuts for the petrochemical industry, while supplying the refinery with the hydrogen necessary for other operations.

The catalytic reforming process consists in bringing the cut of hydrocarbons containing paraffinic compounds and naphthenes, into contact with hydrogen and a reforming catalyst, for example a platinum catalyst, and in converting the paraffinic compounds and naphthenes into aromatic compounds with associated production of hydrogen. Since the reactions involved in the reforming process are endothermic, it is advisable to heat the effluent withdrawn from one reactor before sending it to the next reactor.

Over time, the reforming catalyst becomes deactivated due to the deposition of coke on its active sites. Consequently, in order to maintain an acceptable productivity of the reforming unit, it is necessary to regenerate the catalyst in order to remove the deposit and thus restore its activity.

There exist various types of reforming processes: “nonregenerative”, “semiregenerative” and “continuous” reforming. The continuous catalytic reforming or CCR process involves carrying out the reaction in a reactor in which the catalyst flows continuously from the top downward and the regeneration takes place continuously in an appended reactor, the catalyst being recycled to the main reactor so as not to interrupt the reaction. Only this type of catalytic reforming will be broached in the continuation of the description.

Reforming brings together several types of reactions which take place in parallel, in particular balanced isomerization, dehydrogenation and dehydrocyclization reactions. These reactions produce aromatic rings under conditions of low H₂ contents. In point of fact, depending on the progress in the series of reactors, the predominant reactions are not the same. For example, the dehydrogenation of naphthenes, which is very rapid, takes place mainly in the first reactors. The isomerization reactions, which are slower, take place more gradually in all the reactors, while the cracking of the naphthenes mainly takes place in the last reactor. The catalyst employed must make it possible to provide all the reactions required, while retaining good activity, good selectivity and good stability, whatever the reaction carried out.

In addition, the reforming reactions generate hydrogen (H₂), while the cracking side reactions consume it. Thus, without controlling the H₂ content, the side reactions can lead to a deterioration in the yield of compounds having a carbon number of greater than or equal to 5 (C5+), and more particularly of aromatic compounds. Typically, the side reactions are cracking or alkylation. These reactions are minimized by a low H₂ content. The hydrogen content thus plays an important role in the final yield of aromatic compounds.

However, hydrogen also has a key role in the formation of coke in the reactors. The formation of coke thus depends on the H₂ concentration but also on the content of total naphthene, the temperature, the pressure and the cycle time. As the content of naphthenes is higher in the first reaction zone, the coke is predominantly formed in this first zone. In a process having a single reaction zone having 4 reactors, the catalyst coked in reactors 1 and 2 is gradually moved into the reactors 3 and 4, thus causing a significant deactivation of the catalyst in the 4 reactors and thus a decrease in the yield of aromatic compounds. Consequently, hydrogen is added in the reforming process to limit the formation of coke, in order to prevent premature deactivation of the catalyst involving an excessively short cycle time and thus an excessively frequent regeneration. This is why, in the conventional configuration, a part of the hydrogen loops around in the process between the inlet of the first reaction zone and the outlet of the second reaction zone via a compressor and a recycle loop, after a disengager, in order for the catalyst to have a sufficient hydrogen supply to limit the coke content.

The document FR 2 946 660 describes a configuration of the reforming process as described above with recycling of the reduction effluent at the outlet of the catalyst regeneration zone, to the last reactors of the reaction zone. Such a process makes it possible to decrease the formation of coke in the last reactors and to balance the reactions throughout the process, but also results in a decrease in dehydrocyclization making possible the production of aromatics, an increase in the formation of coke and an acceleration in undesirable dehydrocyclization reactions.

The document FR 2 961 215 relates to a process for the regenerative catalytic reforming of gasolines which is derived from the preceding process with in particular the recycling of a part at least of the effluent from the zone of reduction of the catalyst, at the inlet of the head of the first reactor. This process makes it possible to improve the production of reformate (better yield of C5+) and the hydrogen balance. Unfortunately, in processes of this type, the coke content is managed over all of the reactors, and it is thus difficult to limit and to control the total hydrogen supply. Consequently, the cracking reactions remain significant, thus detrimentally affecting the conversion and therefore the yield of aromatic compounds. Also, this process uses a compressor for the purpose of recycling the hydrogen to the various reactors, and it represents a not insignificant cost, of between 20% and 40% of the cost of the unit. Finally, the use of a single type of catalyst does not make it possible to be suitable for the different reactions which take place throughout the process.

Processes devoid of compressor and employing several reaction zones, in order to have a specific catalyst for a given reaction zone and to thus be able to adjust and control the reactions according to the reaction zones, have therefore been developed.

The documents EP 2 995 379 and EP 2 995 380 deal with reforming processes with continuous regeneration of the catalyst and in particular, under different operating conditions, by means of regeneration zones separated from one another. In a standard way, the gaseous effluent passes in series into each of the reactors then into furnaces before entering the following reactor (endothermic reactions) and the mobile catalyst descends by gravity in each of the reactors and is then raised by lifts to the top of the following reactor. It is finally purged of the hydrogen it contains and sent to the regenerator where the coke is incinerated in a controlled way in order to restore the activity of the catalyst. The process is characterized by a continuous regenerator cut into four zones which the catalyst travels through by gravity. The first two zones make possible the combustion of the coke. The temperature and the partial oxygen pressure are controlled in order to provide directed and complete combustion of the coke. An additional supply of air and of quench gas between the two combustion zones makes it possible to regulate the temperature and the oxygen concentration at the inlet of the second bed. After combustion, the catalyst flows to the last two zones where the oxychlorination (restoration of catalytic activity, redispersion in particular of the metallic phase) and calcination reactions take place. In these two zones, a gas different from the combustion gas circulates, this time countercurrentwise, and a new extra contribution of gas, rich in gaseous chlorine (caused by the decomposition of a chlorinating agent) but poor in oxygen, is introduced with the oxychlorination. This double circulation of the catalyst makes it possible to manage different circulation rates in the two reaction zones and thus to work with different catalysts and coke levels in said zones.

There would thus be a strong advantage in being able to work with a catalyst optimized for the first reactors, where the first three reforming reactions described above mainly take place.

It remains essential to control the H₂ content, for the purpose of limiting the side reactions and thus promoting the main reforming reactions, in order to improve the yield of aromatic compounds, but also for the purpose of limiting the formation of coke. It is also important to reduce the plant and production costs, by avoiding the use of a compressor. In addition, a better distribution of the H₂ in the different reaction zones would make it possible to reduce the energy consumption and thus to reduce the overall cost of the process.

Surprisingly, the applicant company has developed a new continuous regeneration reforming process, comprising several defined reaction zones and two zones for reduction of the catalyst, in which the reduction effluents are recycled at least in part at the top of the different reaction zones. It then becomes possible to limit the injection of hydrogen at the inlet of the first reaction zone by using the reduction hydrogen, by recycling, and consequently to eliminate the recycle compressor. Thus, both the energy consumption and the operating cost of said device are reduced.

The applicant company has also discovered that the use of an intermediate regenerator within the reforming process makes it possible to increase the yield of aromatics, while limiting the formation of coke, which deactivates the catalyst.

Consequently, according to one embodiment, said process can employ a compartmentalized regenerator making it possible to use a catalyst suitable for a reaction zone, under operating conditions suitable for the specific reactions taking place in said zone and for the degree of coking, by virtue of a compartmentalized intermediate regenerator.

A better understanding of other characteristics and advantages of the invention will be obtained on reading the description given below.

### SUBJECT MATTER OF THE INVENTION

A subject matter of the present invention relates to a process for the catalytic reforming of a hydrocarbon feedstock comprising paraffinic, naphthenic and aromatic hydrocarbons containing from 5 to 12 carbon atoms per molecule, at a temperature of between 400° C. and 700° C., a pressure of between 0.1 and 10 MPa and a flow rate by weight of feedstock treated per unit weight of catalyst and per hour of between 0.1 and 10 h⁻¹, in which process:
said hydrocarbon feedstock (1) is circulated through at least:
   a) a first reaction zone, in the presence of hydrogen, comprising at least a series of two catalytic reforming reactors (R1, R2) comprising a first catalyst circulating in a moving bed; then
   b) a second reaction zone, in the presence of hydrogen, comprising at least a series of two catalytic reforming reactors (R3, R4) comprising a second catalyst circulating in a moving bed, identical to or different from the first catalyst, in order to obtain a reaction effluent (13);
said first and second catalysts are circulated respectively through:
   i) said first reaction zone and said second reaction zone; then
   ii) a first regeneration zone and a second regeneration zone (REG); then
   iii) a first reduction zone and a second reduction zone (RED 1 and RED 2), in the presence of hydrogen, before returning said first and second catalysts, in stage i), to said first reaction zone and said second reaction zone;
   in which process the reduction effluents (4 and 7) obtained at the outlet of each reduction zone (RED 1 and RED 2) are sent at least in part to the top of the first reactor (R1, R3) of each reaction zone.

### DEFINITIONS AND ABBREVIATIONS

It is specified that, throughout this description, the expressions “of between . . . and . . . ” and “comprising between . . . and . . . ” are to be understood as including the limits mentioned.

In the present patent application, the term “to comprise” is synonymous with (means the same thing as) “to include” and “to contain”, and is inclusive or open and does not exclude other elements not stated. It is understood that the term “to comprise” includes the exclusive and closed term “to consist of”.

### BRIEF DESCRIPTION OF THE FIGURES

FIG. 1 represents a general view of a catalytic reforming unit employed in the process of the present invention, comprising a zone for intermediate regeneration of the catalyst and two reaction zones, themselves composed of two reactors in series (R1, R2 and R3, R4) and of a reduction zone (RED 1 and RED 2), where at least a part of the reduction effluent is sent to the top of the first reactor (R1, R3) of each reaction zone.

According to one embodiment, the reduction effluents obtained at the outlet of each reduction zone (RED 1 and RED 2) via the lines 4 and 7 are sent at least in part to the top of the first reactor (R1, R3) of each reaction zone via the lines 6 and 11 and at least in part mixed via the lines 5 and 12 with the fresh hydrocarbon feedstock via the line 1.

### DETAILED DESCRIPTION OF THE INVENTION

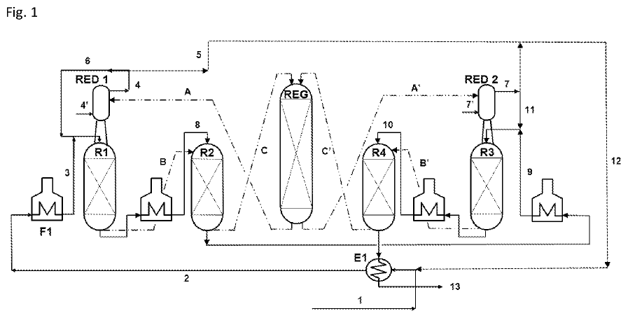

Within the meaning of the present invention, the different embodiments presented can be used alone or in combination with one another, without any limit to the combinations. The detailed description which follows is given in connection with FIG. 1.

The present invention relates to a process for the catalytic reforming of a hydrocarbon feedstock comprising paraffinic, naphthenic and aromatic hydrocarbons containing from 5 to 12 carbon atoms per molecule, at a temperature of between 400° C. and 700° C., a pressure of between 0.1 and 10 MPa and a flow rate by weight of feedstock treated per unit weight of catalyst and per hour of between 0.1 and 10 h⁻¹, in which process:
said hydrocarbon feedstock (1) is circulated through at least:
   a) a first reaction zone, in the presence of hydrogen, comprising at least a series of two catalytic reforming reactors (R1, R2) comprising a first catalyst circulating in a moving bed; then
   b) a second reaction zone, in the presence of hydrogen, comprising at least a series of two catalytic reforming reactors (R3, R4) comprising a second catalyst circulating in a moving bed, identical to or different from the first catalyst, in order to obtain a reaction effluent (13);
said first and second catalysts are circulated respectively through:
   i) said first reaction zone and said second reaction zone; then
   ii) a first regeneration zone and a second regeneration zone (REG); then
   iii) a first reduction zone and a second reduction zone (RED 1 and RED 2), in the presence of hydrogen, before returning said first and second catalysts, in stage i), to said first reaction zone and said second reaction zone;
   in which process the reduction effluents (4 and 7) obtained at the outlet of each reduction zone (RED 1 and RED 2) are sent at least in part to the top of the first reactor (R1, R3) of each reaction zone.

The process according to the invention relates to the reforming of a feedstock of paraffinic, naphthenic and aromatic hydrocarbons containing from 5 to 12 carbon atoms per molecule, at a temperature of between 400° C. and 700° C., a pressure of between 0.1 and 10 MPa and a flow rate by weight of feedstock treated per unit weight of catalyst and per hour of between 0.1 and 10 h⁻¹.

Preferentially, said hydrocarbon feedstock is a naphtha cut.

### Circulation of the Hydrocarbon Feedstock

The hydrocarbon feedstock 1 circulates through at least two reaction zones, each comprising at least two catalytic reforming reactors respectively denoted R1, R2 for the first reaction zone and R3, R4 for the second reaction zone, represented in FIG. 1 in “side-by-side” configuration. The reactors are placed in series.

In the context of the invention, the process can comprise more than two reaction sections which each operates with catalysts of identical or different compositions. The different reaction zones can be arranged in vertical stacking in one and the same reactor or respectively in at least a first reactor and at least a second reactor, arranged side-by-side, as represented in FIG. 1.

The hydrocarbon feedstock 1 passes through the effluent/feedstock exchanger E1 and then the preheating furnace F1 via the line 2, before being introduced into the first reactor R1 of the first reaction zone, via the line 3, comprising at least a first catalyst and hydrogen. Subsequently, said feedstock passes through the second reactor of the first reaction zone R2 via the line 8 and then passes through the reactors R3 and R4 of the second reaction zone via lines 9 and 10, in order to obtain a reaction effluent via the line 13.

The reaction effluent is recovered at the outlet of the last reactor R4 of the last reaction zone, cooled in the effluent/feedstock exchanger E1 and recovered at the outlet 13. The reaction effluent 13 undergoes a treatment (not indicated in FIG. 1) in order to separate the hydrogen and the cracked products, preferentially the compounds having a carbon number of less than or equal to 4, on the one hand, and the reformate comprising the compounds comprising a carbon number of greater than or equal to 5, on the other hand.

The flow of the hydrocarbon feedstock, of the reaction effluents and of the first and second catalysts circulating in moving beds takes place cocurrentwise along a downward direction. Preferably, the moving beds are of “radial” type.

### Catalyst Type

The catalyst(s) used in the context of the process according to the invention comprise(s) an active phase and a support.

### The Active Phase

Said active phase comprises at least one metal from Group VIII of the Periodic Table, optionally one or more promoter metals, at least one dopant and/or one halogen.
The metal from Group VIII of the Periodic Table is preferentially platinum. The content of said metal, with respect to the total weight of the catalyst, is of between 0.02% and 2% by weight, preferably between 0.05% and 1.5% by weight and more preferably still between 0.1% and 0.8% by weight.
The promoter metal is chosen from the metals from Group VIII of the Periodic Table, such as rhenium and iridium. The content of each promoter metal is of between 0.02% and 10% by weight, with respect to the total weight of the catalyst, preferably between 0.05% and 5% by weight and more preferably still between 0.1% and 2% by weight.
The dopant is chosen from the group formed by gallium, germanium, indium, tin, antimony, thallium, lead, bismuth, titanium, chromium, manganese, molybdenum, tungsten, rhodium, zinc and phosphorus. Preferably, several dopants are used in the context of the process according to the invention. The content of each dopant can be, with respect to the total weight of the catalyst, of between 0.01% and 2% by weight, preferably between 0.01% and 1% by weight, more preferentially between 0.01% and 0.7% by weight.
The halogen is preferentially chlorine. The halogen content represents between 0.1% and 15% by weight, with respect to the total weight of the catalyst, preferably between 0.2% and 5%, with respect to the total weight of the catalyst. When the catalyst comprises a single halogen, which is chlorine, the chlorine content is of between 0.5 and 2% by weight relative to the total weight of the catalyst.

### The Support

The porous support of the catalyst used in the context of the process according to the invention is based on alumina. The alumina(s) of the porous support used in the catalyst can be of any type and can be synthesized by different methods known to a person skilled in the art. The porous support is provided in the form of beads with a diameter of between 1 and 3 mm, preferably between 1.5 and 2 mm, without these values being limiting.

The shaping of the porous support by any method well known to a person skilled in the art can be carried out before or after all the constituents have been deposited on said porous support.

### Preparation

The catalyst used in the context of the process according to the invention can be prepared by any technique well known to a person skilled in the art, for example by dry impregnation or by liquid- or gas-phase deposition. The metal from Group VIII can be deposited by conventional techniques, in particular the impregnation from an aqueous or organic solution of a precursor of platinum or containing a salt or a compound of platinum. The dopant(s) and/or the promoter metal(s) can also be deposited by conventional techniques starting from precursor compounds, such as organometallic compounds of said metals, phosphorus-based compounds, halides, nitrates, sulfates, acetates, tartrates, citrates, carbonates or oxalates of the dopant metals and complexes of the amine type. According to one embodiment, the halogen can be added to the catalyst by means of an oxychlorination treatment.

Before its use, the catalyst is subjected to a treatment under hydrogen and to a treatment using a sulfur-based precursor in order to obtain an active and selective metal phase. The procedure for this treatment under hydrogen, also referred to as reduction under hydrogen, consists in maintaining the catalyst in a stream of pure or diluted hydrogen at a temperature of between 100 and 600° C., and preferably between 200 and 580° C., for 30 minutes to 6 hours. This reduction may be performed immediately after the calcination, or later by the user. It is also possible for the user to directly reduce the dried product. The procedure for treatment using a sulfur-based precursor is carried out after the reduction. The treatment with sulfur (also referred to as sulfurization) is carried out by any method that is well known to those skilled in the art.

### Circulation of the Catalyst

The catalyst circulates in a moving bed in the different reactors via the lines B and B′ of each reaction zone. The catalysts of the different reaction zones can be identical or different.

In the case where said first and second catalysts are identical, said first and second intermediate regeneration zones form only one and the same common intermediate regeneration zone. The level of coke produced at the outlet of the first reaction zone is of between 3% and 7% by weight, preferably between 4% and 6%, with respect to the total weight of the first catalyst. The level of coke produced at the outlet of the second reaction zone is of between 3% and 7% by weight, preferentially between 4% and 6%, with respect to the total weight of the second catalyst.

In the case where said first and second catalysts are different, said first and second intermediate regeneration zones form only one and the same compartmentalized intermediate regeneration zone.

The catalyst is traversed substantially radially by the feedstock to be treated 1, by the reduction effluents 6 and 11 and by the different intermediate effluents 8, 9 and 10, respectively at the inlet of the reactors R2, R3 and R4.

Each reaction zone can comprise one or more moving catalyst beds.

On leaving the last reactor of each reaction zone via the lines C and C′, the catalyst enters the regeneration zone REG, which comprises, successively and in the following order of circulation of said first and second catalysts:
a section for combustion of the coke deposited on the catalyst (I);
an oxychlorination section making it possible to redisperse the crystallites (II); and
a calcination section for reducing the oxides of the catalyst.

### Combustion Section

Each combustion section comprises an annular space, delimited by two screens permeable to gases and impermeable to the catalysts, in which the catalyst circulates by gravity. Preferentially, said annular space is divided into portions by separation means impermeable to the catalysts; preferably, said separation means are also gastight. Said portions are capable of respectively containing catalyst of different composition.

The screens are chosen from any means well known to a person skilled in the art, such as, for example, a grid or a perforated plate.

### Oxychlorination Section

Each oxychlorination section is obtained by the partition of a zone of the chamber into a compartment by a separation means impermeable to the catalysts; preferentially, said separation means is also gastight. Preferably, the oxychlorination section is separated from the calcination section by a mixing section configured to carry out mixing of an oxychlorination gas with a calcination gas.

### Calcination Section

Each calcination section is obtained by the partition of a zone of the chamber into a compartment by a separation means impermeable to the catalysts; preferably, the separation means is also gastight.

The catalyst circulates by gravity within the intermediate regeneration zone.

In the case where the catalysts used in the different reaction zones are different, the regeneration zone simultaneously and separately treats at least two reforming catalysts circulating in a moving bed, these catalysts being capable of carrying out specific catalytic reactions depending on the progress of the conversion. The regeneration zone thus makes it possible to mutualize the treatment of at least two types of catalysts of different compositions, suitable for specifically carrying out reactions involved in the catalytic reforming of naphtha cuts having low octane numbers.

Preferably, the intermediate regenerator is compartmentalized when the catalyst of the first reaction zone is different from the catalyst of the second reaction zone; for example, a compartmentalized regenerator as described in the patent EP 2 995 379 can be used. Thus, the catalysts are treated under conditions specific for each type of catalyst of each reaction zone, with potentially differences in flow rates of the catalyst, in gas flow rates or in gas compositions, or also, for example, the acidity of the first reactor of the first reaction zone can be reduced because this condition is not necessary for the dehydrogenation of the naphthenes and the temperature in the first reaction zone can also be reduced because the dehydrogenation of the naphthenes can be carried out at a lower temperature, thus limiting the content of coke over the first reaction zone.

The term “composition” is understood to mean the elements which constitute the catalyst, namely the support and the active metallic phase.

In order to be able to regenerate the catalyst of each reaction zone within the same intermediate regenerator REG, the first reaction zone produces a level of coke equivalent to the level of coke produced by the second reaction zone. Thus, the regenerator REG can be proportioned according to a target level of coke. The cycle time, the pressure, the temperature and the amount of hydrogen at the inlet of the regenerator REG are thus adjusted in order to observe said target.

After having circulated in the intermediate regeneration zone in order to be regenerated, the catalyst enters the reduction zones RED 1 and 2 via the lines A and A′, in order to be reduced therein in the presence of a gas rich in hydrogen via the lines 4′ and 7′. The reduced catalyst leaves the reduction zone in order to enter, at the top of the first reactor, of its reaction zone (R1 or R3).

The lines 4′ and 7′ originate from the high-pressure recontacting drum (not represented in FIG. 1) or result from a hydrogen purification well known to a person skilled in the art. The lines 4′ and 7′ have a hydrogen content of greater than 90 mol %. The H₂/HC ratio of the stream entering R1, corresponding to the mixture of the lines 3 and 6, is of between 0.10 and 0.40, which is sufficient to control the content of coke in the first reaction zone. The H₂/HC ratio of the flow entering R3, corresponding to the mixture of the lines 9 and 11, is of between 1.30 and 1.80, preferably between 1.40 and 1.70. As the residence time increases, the reforming reactions release hydrogen which makes it possible to slow down the formation of coke.

The second reaction zone is fed with a low flow rate of hydrogen resulting from the reduction effluent from the reduction zone RED 2, in addition to the hydrogen introduced and produced in situ in the first reaction zone.

The reduction stages RED 1 and RED 2 generate a reduction gas referred to as reduction effluent and respectively denoted 4 and 7. These reduction effluents 4 and 7 are at least in part sent to the top of the first reactor of each reaction zone, i.e. respectively via the line 6 going to R1 and via the line 11 going to R3. Preferentially, said reduction effluents 4 and 7 are at least in part sent to the top of the first reactor of each reaction zone (R1, R3) and at least in part via the lines 5 and 12 mixed with the fresh hydrocarbon feedstock 1.

The recycling of these effluents, which contain water and chlorine, makes possible the reabsorption of the chlorinated compounds and water on the catalyst of the first reaction zone and consequently makes it possible to reduce the consumption of chlorine and water in the process. Also, at the top of the first reactor of the second reaction zone R3, the reduction effluent 7 can be mixed directly with the partially converted feedstock at the reactor inlet via the line 11 or be redirected to the effluent/feedstock exchanger via the line 12, in order to increase the H₂/HC ratio of the first reactor of the first reaction zone (R1).

The reduction effluents corresponding to the lines 4 and 7 are much less rich in hydrogen than the gases introduced corresponding to the lines 4′ and 7′, with a hydrogen content of between 80 molar % and 87 molar %. The reduction effluents 4 and 7 leaving the reduction stages RED 1 and RED 2 are the only sources of hydrogen additional to that formed in situ. Said reduction effluents 4 and 7 have a pressure of between 0.47 and 0.57 MPa, and a temperature of between 450° C. and 520° C. The hydrogen content of said reduction effluents 4 and 7 is of between 90% and 99.9% by volume, with respect to the total volume of said reduction effluents 4 and 7. The chlorine content of said effluents is of between 20 and 50 ppm by volume, with respect to the total volume of said reduction effluents 4 and 7. Said effluents have a water content of between 50 and 100 ppm by volume, with respect to the total volume of said reduction effluents 4 and 7. The pressure at the inlet of the first reactors of each reaction zone, i.e. R1 and R3 respectively, is of between 0.45 and 0.6 MPa, preferentially between 0.46 and 0.58 MPa.

The following examples illustrate the invention without limiting the scope thereof.

### EXAMPLES

The naphtha feedstock used in the continuation of the example has the following properties:

TABLE 1
Table 1- Characteristics of the naphtha feedstock

| | |
|---|---|
| Paraffins (wt %) | 56.4 |
| Naphthenes (wt %) | 30.5 |
| Aromatics (wt %) | 13.1 |
| Density (kg/m³) | 0.7428 |
| Mean boiling point (° C.) | 116.3 |

The catalyst used in the continuation of the example is a catalyst comprising 0.25% of platinum and 0.3% of tin supported on a chlorinated alumina base.

The reference process consists of a conventional sequence of 4 adiabatic reactors, without intermediate catalyst regeneration, with a standard H₂/HC ratio of 2.

Three other processes were simulated with the same feedstock and the same catalyst:
Case 1 (not in accordance with the invention): reforming process with a low H₂/HC ratio at the inlet of the first reaction zone, without zone for intermediate regeneration of the catalyst.
Case 2 (in accordance with the invention): reforming process with a low H₂/HC ratio at the inlet of the first reaction zone, with intermediate regeneration of the catalyst and with an extra contribution of hydrogen.
Case 3 (in accordance with the invention): reforming process with a slightly higher H₂/HC ratio than the other two cases, with intermediate regeneration of the catalyst and with an extra contribution of hydrogen.

The results of the different processes are given in table 2 below. The yields of H₂, of C4− and C5+ compounds and of total aromatics and the desired C5+ octane number are expressed as percentage by weight, with respect to the total flow rate by weight of the injected fresh hydrocarbon feedstock. The percentages of coke at the outlet of the reaction zones 1 and 2 are expressed with respect to the weight of catalyst.

TABLE 2
Results of calculations

| | | Case 1 | Case 2 | Case 3 |
|---|---|---|---|---|
| | Refer- | (not in | (in accord- | (in accord- |
| | ence | accordance) | ance) | ance) |
| Pressure Reactor R1 | 0.38 | 0.38 | 0.38 | 0.38 |
| (MPa) | | | | |
| Mean temperature at | 530 | 530 | 530 | 530 |
| the inlet of the first | | | | |
| reactors (R1, R3) (° C.) | | | | |
| H₂/HC at the entrance | 2 | 0.2 | 0.2 | 0.4 |
| of the first reaction | | | | |
| zone (mol/mol) | | | | |
| Extra H₂/HC added | NA | NA | 0.2 | 0.4 |
| at the inlet of the | | | | |
| second reaction | | | | |
| zone (mol/mol) | | | | |
| Number of reaction | 1 | 1 | 2 | 2 |
| zones | | | | |
| Catalyst regeneration | R4 | R4 | R2 and | R2 and |
| after the reactor | | | R4 | R4 |
| Residence time of the | 5 | 3 | 2 | 2 |
| catalyst reaction | | | | |
| zone 1 (days) | | | | |
| Residence time of | NA | NA | 8 | 8 |
| the catalyst reaction | | | | |
| zone 2 (days) | | | | |
| Results | | | | |
| Yield H₂ (wt %) | 3.63 | 3.30 | 3.84 | 3.86 |
| Yield of C4− | 7.98 | 10.05 | 8.72 | 8.70 |
| compounds (wt %) | | | | |
| Yield C5+ (wt %) | 88.39 | 86.65 | 87.44 | 87.44 |
| Yield of total aromatics | 72.01 | 68.82 | 74.34 | 74.07 |
| (wt %) | | | | |
| Desired C5+ Octane | 102.72 | 102.36 | 104.68 | 104.51 |
| Number | | | | |
| Coke at the outlet | 5.10 | 11.48 | 4.80 | 5.20 |
| of the reaction | | | | |
| zone 1 (wt %) | | | | |
| Coke at the outlet | NA | NA | 5.31 | 4.7 |
| of the reaction | | | | |
| zone 2 (wt %) | | | | |

According to the table of results, a gain in yield of total aromatics of 2 points, with respect to the reference, is found. The high content of coke at the reaction zone outlet, accompanied by a drop in yield of aromatics of 3.2 points, is also noticed when the H₂/HC ratio is reduced (Reference and Case 1) and despite the fall in the residence time of the catalyst in the reaction zone. In conclusion, the intermediate regeneration makes it possible to increase the yield of total aromatics, while significantly limiting the formation of coke and while retaining a low H₂/HC ratio.

1. A process for the catalytic reforming of a hydrocarbon feedstock comprising paraffinic, naphthenic and aromatic hydrocarbons containing from 5 to 12 carbon atoms per molecule, at a temperature of between 400° C. and 700° C., a pressure of between 0.1 and 10 MPa and a flow rate by weight of feedstock treated per unit weight of catalyst and per hour of between 0.1 and 10 h⁻¹, in which process:
said hydrocarbon feedstock (1) is circulated through at least:
a) a first reaction zone, in the presence of hydrogen, comprising at least a series of two catalytic reforming reactors (R1, R2) comprising a first catalyst circulating in a moving bed; then
b) a second reaction zone, in the presence of hydrogen, comprising at least a series of two catalytic reforming reactors (R3, R4) comprising a second catalyst circulating in a moving bed, identical to or different from the first catalyst, in order to obtain a reaction effluent (13);
said first and second catalysts are circulated respectively through:
i) said first reaction zone and said second reaction zone; then
ii) a first regeneration zone and a second regeneration zone (REG); then
iii) a first reduction zone and a second reduction zone (RED 1 and RED 2), in the presence of hydrogen, before returning said first and second catalysts, in stage i), to said first reaction zone and said second reaction zone;
in which process the reduction effluents ( 4 and 7) obtained at the outlet of each reduction zone (RED 1 and RED 2) are sent at least in part to the top of the first reactor (R1, R3) of each reaction zone.

2. The process as claimed in claim 1, in which said first and second catalysts are identical.

3. The process as claimed in claim 2, in which said first and second intermediate regeneration zones form only one and the same common regeneration zone.

4. The process as claimed in claim 2, in which the level of coke produced at the outlet of the first reaction zone is of between 3% and 7% by weight, with respect to the total weight of the first catalyst.

5. The process as claimed in claim 2, in which the level of coke produced at the outlet of the second reaction zone is of between 3% and 7% by weight, with respect to the total weight of the second catalyst.

6. The process as claimed in claim 1, in which said first and second catalysts are different.

7. The process as claimed in claim 6, in which said first and second intermediate regeneration zones form only one and the same compartmentalized regeneration zone.

8. The process as claimed in claim 1, in which said first and second catalysts circulate by gravity within said first and second intermediate regeneration zones.

9. The process as claimed in claim 1, in which the regeneration zone (REG) comprises, successively and in the following order of circulation of said first and second catalysts:
a stage of combustion of the coke deposited on the catalyst (I);
an oxychlorination stage making it possible to redisperse the crystallites (II); and
a calcination stage for reducing the oxides of the catalyst.

10. The process as claimed in claim 1, in which the reduction effluents (4 and 7) obtained at the outlet of each reduction zone (RED 1 and RED 2) are at least in part (5 and 12) mixed with the fresh hydrocarbon feedstock (1).

11. The process as claimed in claim 1, in which the hydrocarbon feedstock is a naphtha cut.

12. The process as claimed in claim 1, in which said catalysts comprise a support and an active phase, said active phase comprising at least one metal from Group VIII, optionally at least one promoter metal, at least one dopant and/or a halogen.

13. The process as claimed in claim 12, in which the metal from group VIII is platinum.
